(19) United States
(12) Patent Application Publication
(10) Pub. No.: US 2022/0207096 A1
(43) Pub. Date: Jun. 30, 2022

(54) Search Enhanceer Interface Using Multiple Dictionaries

(71) Applicant: Giving Tech Labs, LLC, Seatte, WA (US)

(72) Inventors: Luis Salazar, Kirkland, WA (US); Ying Li, Bellevue, WA (US)

(73) Assignee: Giving Tech Labs, LLC, Seattle, WA (US)

(21) Appl. No.: 17/138,750

(22) Filed: Dec. 30, 2020

(51) Int. Cl. G06F 16/9532; G06F 16/9032; G06F 40/242

(52) U.S. Cl. CPC G06F 16/9532; G06F 40/242; G06F 16/90332; G06F 16/90324

(57) ABSTRACT

A search query may be expanded using one or more dictionaries from different knowledge domains or user intent. A search query may be analyzed to find keywords for which an expanded definition may exist, and a user may be able to select an expanded definition of that keyword to better hone their intent. A query may be expanded using Boolean AND, OR, or NOT statements for an expanded definition of the highlighted keyword. Results may be presented that may include the expanded definition. In some cases, different dictionaries may be selected by the user to match their search intent. Dictionaries may be professionally curated or may be developed from a user's history of search or other work product.

### BACKGROUND

Today's search experience uses keywords to search against an index of websites. Common keyword matching often returns something not quite expected, simply because the user's query is either too broad or too narrow. Broad keywords return results with lots of websites that are irrelevant. Narrow keywords return results that may have missed interesting websites.

### SUMMARY

A search query may be expanded or enhanced using one or more dictionaries from different knowledge domains or user intent. A search query may be analyzed to find keywords for which an expanded definition may exist, and a user may be able to select an expanded definition of that keyword to better hone their intent. A query may be expanded using Boolean AND, OR, or NOT statements for an expanded definition of the highlighted keyword. Results may be presented that may include the expanded definition. In some cases, different dictionaries may be selected by the user to match their search intent. Dictionaries may be professionally curated or may be developed from a user's history of search or other work product.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

In the drawings,

FIG. 1 is a diagram illustration of an example embodiment showing a search query enhancement system in a series of user interfaces.

FIG. 2 is a diagram illustration of an embodiment showing a network environment with a search query enhancement system.

FIG. 3 is a flowchart illustration of an embodiment showing a method for enhancing a search query.

FIG. 4 is a diagram illustration of an embodiment showing a sequence for improving search query enhancements.

FIG. 5 is a flowchart illustration of an embodiment showing a method for improving search query enhancements.

### DETAILED DESCRIPTION

Enhanced Definitions in Search Queries

A search query may be enhanced or expanded by identifying a search term and expanding that search term to include other related search terms. In a typical use case, a search term may be highlighted and, before sending the search query to a search engine, a user may be given the opportunity to expand, narrow, or modify the term. The user may be presented with different options to select, deselect, remove, or otherwise change to modify the highlighted search term.

A modified search query may be created from the enhanced search terms, often in the form of Boolean OR, AND, or NOT statements for the different options selected. The modified search term may be sent to a search engine, which may return a set of websites or other results. Within the results, the modified search terms may be highlighted to indicate the expanded terms used for searching. Some systems may show these Boolean statements to the user while other systems may not.

Several different dictionaries may be available to a user for expanding their search queries. The dictionaries may be specialized by technologies, such as dictionaries for scientific, medical, engineering, or other technologies. Other dictionaries may be available by knowledge domains, such as dictionaries specialized for non-profits, legal, art history, or any other knowledge domains.

In some cases, a user may manually or automatically curate their own dictionary. A user-specific dictionary may contain information gathered from their search history, their writings, their organization's output, and other sources. As a user performs searches, the user may be queried to determine whether or not the expanded definition helped them. If so, the expanded definition may be retained as a default for future searches. As a user creates content, such as emails, blog posts, or work product such as reports, proposals, and the like, those content pieces may be aggregated into a dictionary that represents the user's work context.

Some systems may allow a user to create a specific dictionary for different domains or specialties within their own lives. For example, a technologist may have dictionaries for their use in their working lives, but a separate set of dictionaries they use for their hobbies, religious studies, or other interests.

A dictionary may be constructed as a graph that links concepts through different relationships. The graph may be constructed where the nodes contain concepts, sometimes thought of as nouns, and edges or relationships, sometimes thought of as verbs. The graph may be adjusted by changing the value or strength of relationships between concepts. Such values may change based on the degree to which a user may be interested in the neighboring concept.

User Experience for Enhanced Search

A search system may generate an enhanced query for a user by identifying a search term and providing user interface mechanisms through which a user may expand, narrow, and modify the search query. A search term may be highlighted and a set of user interface controls may be presented for the user to review or modify the enhanced offerings.

In one use case, a user may be presented with options to expand the highlighted search term. One such user experience may be to list several related search terms and give the user the opportunity to include or exclude the search terms. The additional search terms may be considered alternatives to the highlighted search term.

For example, a user may wish to execute a search using the term “mental illness,” and, in this example, the starting search query may be “what are the effects of mental illness on age?” The term “mental illness” may be highlighted as having an expanded definition.

In the example, a user may be presented with examples of specific mental illnesses, such as “depression” or “anxiety.” In some cases, the user may be presented with classes of mental illnesses, such as “cognitive illnesses,” “eating disorders,” and “psychotic disorders.” Each of the classes of mental illnesses may be further expanded to list example of each of the classes. For example, the class of “eating disorders” may be expanded to include “anorexia” and “bulimia.”

A user in the example may be given the opportunity to add all of the specific illnesses shown, to select some of the illnesses, or to discard the illnesses as alternative definitions or refinements to the general term “mental illness.” These modifications to the term “mental illness” may be added to the search query so that the search intent of the user is better identified.

The user's interaction with the dictionary may identify the user's interests or intent for the search. Further, the dictionary interaction may allow the user to clarify their intent so that their search results are more fruitful. In many cases, a user may not know exactly how to phrase their query appropriately, especially when the user may not be an expert in a field. In our example of “mental illness,” a layperson may not appreciate the scope of mental illness, and they may be wanting to focus on just a subset of the term. The dictionary interaction may allow them to refine their query by navigating the options within the term “mental illness.”

As the user repeats various searches, their previous selections and preferences may be stored in a personal dictionary. The personal dictionary may be used to pre-populate a selection for future queries. In some cases, a group or organization may use a corporate dictionary that may be tailored for the group's particular interests. In one example, a non-profit organization that focuses on helping people with psychotic mental illnesses may prioritize search results within that field, while de-prioritizing search results outside of the psychotic mental illnesses.

Throughout this specification and claims, the term “expanded” or “enhanced” search queries may be used synonymously. The general term of “enhancing” a search query may include expanding a keyword to include other terms. In some cases, such terms may change the scope of a search by including narrower, more specific keywords. In other cases, such terms may change the scope with more generic keywords that may be more encompassing from the original keyword.

Throughout this specification, like reference numbers signify the same elements throughout the description of the figures.

In the specification and claims, references to “a processor” include multiple processors. In some cases, a process that may be performed by “a processor” may be actually performed by multiple processors on the same device or on different devices. For the purposes of this specification and claims, any reference to “a processor” shall include multiple processors, which may be on the same device or different devices, unless expressly specified otherwise.

When elements are referred to as being “connected” or “coupled,” the elements can be directly connected or coupled together or one or more intervening elements may also be present. In contrast, when elements are referred to as being “directly connected” or “directly coupled,” there are no intervening elements present.

The subject matter may be embodied as devices, systems, methods, and/or computer program products. Accordingly, some or all of the subject matter may be embodied in hardware and/or in software (including firmware, resident software, micro-code, state machines, gate arrays, etc.) Furthermore, the subject matter may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. By way of example, and not limitation, computer readable media may comprise computer storage media and communication media.

Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by an instruction execution system. Note that the computer-usable or computer-readable medium could be paper or another suitable medium upon which the program is printed, as the program can be electronically captured, via, for instance, optical scanning of the paper or other medium, then compiled, interpreted, of otherwise processed in a suitable manner, if necessary, and then stored in a computer memory.

When the subject matter is embodied in the general context of computer-executable instructions, the embodiment may comprise program modules, executed by one or more systems, computers, or other devices. Generally, program modules include routines, programs, objects, components, data structures, etc. that perform particular tasks or implement particular abstract data types. Typically, the functionality of the program modules may be combined or distributed as desired in various embodiments.

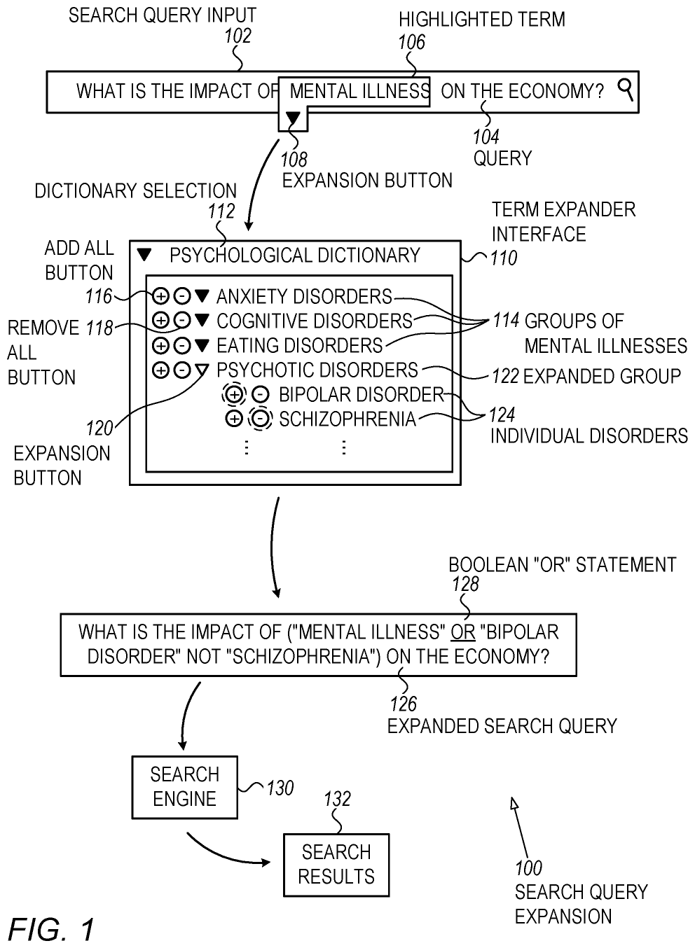

FIG. 1 is a diagram illustration showing an embodiment 100 of a search query expansion. In the example of embodiment 100, a search query is expanded using a dictionary of search terms. A search term is highlighted, and the user may be presented with several user interface components to expand the definition of the highlighted term. Once the user has selected any expanded terms, the search query may be updated and submitted to a search engine.

The example shows how a search term may be expanded using dictionaries. Dictionaries, as used herein, may refer to any type of database that may include alternative definitions for search terms. Some deployments may use a lookup table structured like a thesaurus, where a given search term may have a list of alternative terms. Other deployments may use a “knowledge graph” that includes terms as nodes and relationships between the terms as edges of the graph. The effect of the dictionaries may be to offer different versions of a search term.

A search query input mechanism 102 is illustrated as a text-based input device, where a user may type a search query. Other systems may use audio or other input devices to capture a search term. In some cases, a search term may be received by an application programming interface (API).

In our example the original search query 104 is “What is the impact of mental illness on the economy?” Within the query, a highlighted term 106 is “mental illness.” This term is highlighted because a dictionary contains one or more expanded definitions for the term. In the example, the term is visually highlighted and provided with an expansion button 108, whereby the user may be able to explore, select, and modify the expanded terms for the highlighted term.

It should be noted that the example user interface icons, buttons, and functionality are merely examples of the user interface techniques by which terms may be expanded. Other embodiments may use different icons, buttons, sequences, and user interface mechanisms to assist a user in exploring alternative terms and capture the user's expanded definitions. Some embodiments may not include all of the functionality displayed in this example, and other embodiments may include additional functionality.

A term expander interface 110 may be a mechanism by which a user may explore expanded definitions and select different ways to expand their definition of a highlighted term. In some cases, a user's “expansion” of a term definition may narrow the definition to focus on subsets of the overall term or more precise or limited definition of the term. The notation of “expanding” or “expansion” of the definition may include additional precision or focus, as well as the broadening of the search term.

In the example of embodiment 100, the highlighted term “mental illness” is further refined, clarified, or narrowed by selecting specific illnesses under the heading of “mental illness.” Such an example may be to narrow the term or make the term more precise.

In another example, a user query may include the term “bipolar disorder.” Such a term may be highlighted and a dictionary may provide a broader, more encompassing term such as “psychotic disorders” or an even broader term of “mental illness.” The user interface of the example of embodiment 100 does not include an example of a broadening alternative search term, although such a use case is contemplated.

A dictionary selection 112 in the example of embodiment 100 is illustrated as “psychological dictionary.” A user may be able to switch from one dictionary to another dictionary in different scenarios. For example, a user who may be researching mental illness for a technical paper may want to include technical terms for different mental illnesses of interest to the user. Such a user may select a technical dictionary, here illustrated as a “psychological dictionary.” Other dictionaries may be selected for different scenarios. For example, a user may select a colloquial or common dictionary that may be less scientific, or a user may select a customized dictionary that may include terms specific to their personal interests. Another version of a customized dictionary may be one designed for a group of people, such as an organization, team, or company.

The dictionary selection 112 is illustrated as a hierarchical list. In the list, “mental illness” is arranged in several groups 114. For each group 114, a set of user interface controls may include an “add all” button 116, a “remove all” button 118, and an “expansion” button 120. The “add all” button 116 may function to add all of the instances of mental illnesses in a group to the search query. The “remove all” button 118 may function to exclude the instances of mental illnesses in the search query. The “expansion” button 120 may expand the selection, such that a user may browse the contents of the group and may select or deselect individual members of the group.

In the example, the expanded group 122 entitled “psychotic disorders” is expanded to include individual disorders 124 “bipolar disorder” and “schizophrenia.” Here, the user may have the option to include or exclude each individual disorder in their query. Such a selection may assist the user in focusing on results that may be more relevant to their search task. In our example, the user may have selected “bipolar disorder” through this interface to be included in the search query and selected “schizophrenia” to be excluded.

An expanded search query 126 in our example is constructed to be “What is the impact of (“mental illness” OR “bipolar disorder” NOT “schizophrenia”) on the economy?” The term “(“mental illness” OR “bipolar disorder” NOT “schizophrenia”)” is a Boolean statement that may expand the search query to include the term “bipolar disorder” in addition to the term “mental illness” but exclude results for “schizophrenia.” The expanded search query may be submitted to a search engine 130 and search results 132 may be returned and presented to the user.

The example of embodiment 100 illustrates how a search term may be expanded to include another term and modified to exclude another term. Such a system may allow users to refine their searches by browsing different definitions and including or excluding elements that fit the user's intent.

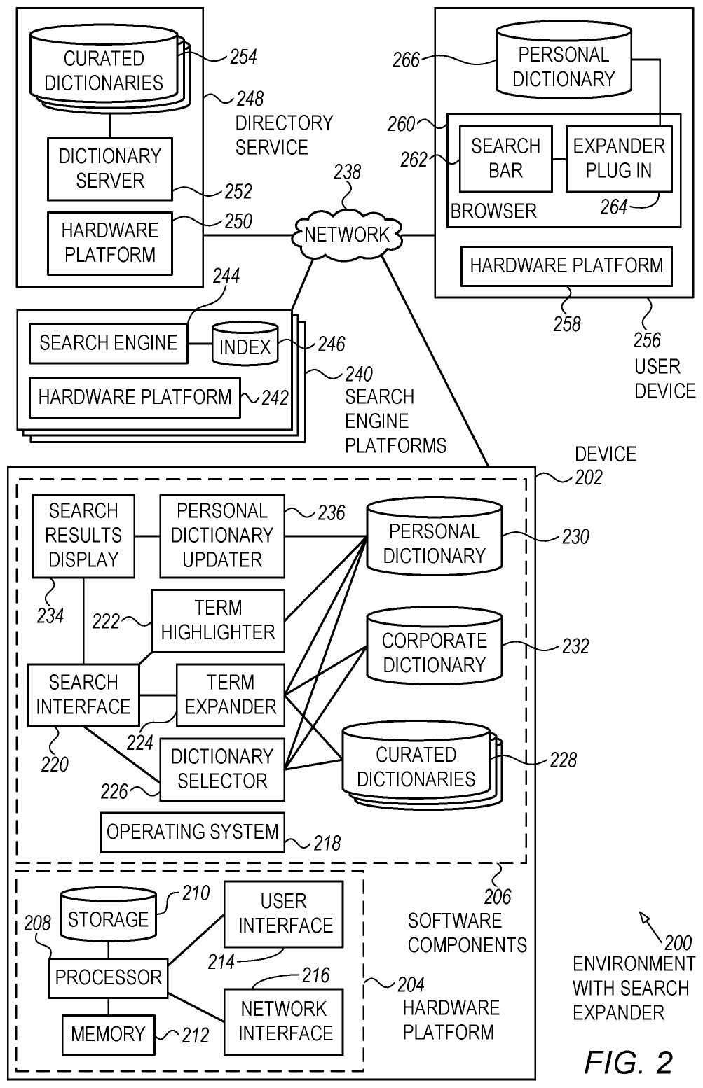

FIG. 2 is a diagram of an embodiment 200 showing components that may deploy search query enhancements across a network. Embodiment 200 is merely one example of an architecture that may analyze a search query, suggest enhancements to the search query, and send the search queries to a search engine.

The diagram of FIG. 2 illustrates functional components of a system. In some cases, the component may be a hardware component, a software component, or a combination of hardware and software. Some of the components may be application level software, while other components may be execution environment level components. In some cases, the connection of one component to another may be a close connection where two or more components are operating on a single hardware platform. In other cases, the connections may be made over network connections spanning long distances. Each embodiment may use different hardware, software, and interconnection architectures to achieve the functions described.

Embodiment 200 illustrates a device 202 that may have a hardware platform 204 and various software components. The device 202 as illustrated represents a conventional computing device, although other embodiments may have different configurations, architectures, or components.

In many embodiments, the device 202 may be a server computer. In some embodiments, the device 202 may still also be a desktop computer, laptop computer, netbook computer, tablet or slate computer, wireless handset, cellular telephone, game console or any other type of computing device. In some embodiments, the device 202 may be implemented on a cluster of computing devices, which may be a group of physical or virtual machines.

The hardware platform 204 may include a processor 208, random access memory 210, and nonvolatile storage 212. The hardware platform 204 may also include a user interface 214 and network interface 216.

The random access memory 210 may be storage that contains data objects and executable code that can be quickly accessed by the processors 208. In many embodiments, the random access memory 210 may have a high-speed bus connecting the memory 210 to the processors 208.

The nonvolatile storage 212 may be storage that persists after the device 202 is shut down. The nonvolatile storage 212 may be any type of storage device, including hard disk, solid state memory devices, magnetic tape, optical storage, or other type of storage. The nonvolatile storage 212 may be read only or read/write capable. In some embodiments, the nonvolatile storage 212 may be cloud based, network storage, or other storage that may be accessed over a network connection.

The user interface 214 may be any type of hardware capable of displaying output and receiving input from a user. In many cases, the output display may be a graphical display monitor, although output devices may include lights and other visual output, audio output, kinetic actuator output, as well as other output devices. Conventional input devices may include keyboards and pointing devices such as a mouse, stylus, trackball, or other pointing device. Other input devices may include various sensors, including biometric input devices, audio and video input devices, and other sensors.

The network interface 216 may be any type of connection to another computer. In many embodiments, the network interface 216 may be a wired Ethernet connection. Other embodiments may include wired or wireless connections over various communication protocols.

The software components 206 may include an operating system 218 on which various software components and services may operate.

A search interface 220 may receive a search query. In many cases, a search query may be a text-based query, although other systems may use audio or application programming interfaces (API). A typical use case may be a website, browser bar, or search app, although any other mechanism by which a search query may be captured may be used with the search expander.

A term highlighter 222 may scan a search query to identify search terms. The search terms that may exist in the various dictionaries may be identified and highlighted. In a typical use case, the highlighting may be a visual highlighting, such as changing the text or background color, font, or other visual cue. Some embodiments may include user interface controls by which a user may be able to engage a term expander 224.

A term expander 224 may present options for enhancing or otherwise expanding the search term. The term expander 224 may allow a user to navigate a knowledge graph, database, or other data structure and identify additional search terms that more closely match the user's intent. Embodiment 100 illustrated one such interaction, where a hierarchical structure of mental illnesses can be navigated to identify groups of terms or specific terms that are more likely to match a user's intent.

The term expander 224 may suggest narrowing or more specific keywords as well as to suggest broadening or more general terms. The example of embodiment 100 illustrated a case where a user's intent was matched by a more specific or narrow set of terms. In the example, a user may be able to highlight terms to include as well as terms to avoid or omit from searching. Terms that may be included may be done with a Boolean “OR” statement, which terms that may be excluded may be done with a Boolean “NOT” statement.

Similarly, a term expander 224 may suggest more general terms that may encompass a broader reach than a user's original search term. Such suggestions may help a user better define the scope of their intended search.

A dictionary selector 226 may allow a user to change from one dictionary to another. In some cases, a user may select two or more dictionaries to use for a single search query modification. The dictionary selector 226 may allow a user to select a preferred dictionary or set of dictionaries, as well as to add, remove, update, and otherwise manage the dictionaries available.

In many cases, a set of curated dictionaries 228 may be available. The curated dictionaries 228 may be specialized dictionaries that may be professionally written or curated. For example, technical dictionaries may be developed for terms in medicine, engineering, physics, or the sciences. Other dictionaries may be developed for the arts, such as art history, architecture, literature, and the like. Some dictionaries may be general language dictionaries, such as thesauruses for English.

A personal dictionary 230 may be a dictionary where a user's preferences relating to specific search terms may be stored. A user's selection of an enhancement to a search query may be saved and reused in later searches. Modifications to the personal dictionary 230 may be made by a personal dictionary updater 236, which may store previous selections.

A personal dictionary updater 236 may query a user after results are presented. Such a query may ask if the enhancements were appropriate for the user's intent. If the enhancements were appropriate, the enhancements may be added to the user's personal dictionary.

A corporate dictionary 232 may be a dictionary shared between coworkers, team members, an organization, or other group. A corporate dictionary 232 may be curated to focus on specific topics of interest for the group, and thereby may assist group members to operate within their knowledge domain of interest.

A network 238 may connect various devices in the illustration.

Several search engine platforms 240 may be used with the enhanced or expanded search query. Each system may have a hardware platform 242 and a search engine 244 that performs queries against an index 246.

The example of embodiment 200 may illustrate a system where a search query may be modified on one device 202, then transmitted to one of the search engines 240. In such a use case, the term expander 224 may be separate from the search engines 240. In other cases, a search engine 240 may include some or all of the features illustrated in device 202.

A dictionary service 248 may provide dictionaries for the device 202. The dictionary service 248 may operate on a hardware platform 250 and have a dictionary server 252 that provides curated dictionaries 254.

In some cases, the dictionary server 252 may replace the curated dictionaries 228. In the example of device 202, the curated dictionaries 228 may be illustrated as being on device 202. In other cases, one or more of the curated dictionaries 228 may be located remotely and served by the dictionary server 252. In an example of such a case, the term expander 224 may communicate over the network 238 to the dictionary service 248 to retrieve dictionary information as each search term may be analyzed.

One use case of the system may be through a user device 256, which may have a hardware platform 258. A browser 260 may have a plugin 264, which may detect a search bar 262. The expander plugin 264 may perform the functions of the device 202 to highlight search terms and suggest enhancements that can be selected by the user. In some cases, the expander plugin 264 may execute some or all of the functions of the term highlighter 222, term expander 224, and other components. In other cases, the expander plugin 264 may display the user interface while the term highlighter and term expander processes may execute on device 202.

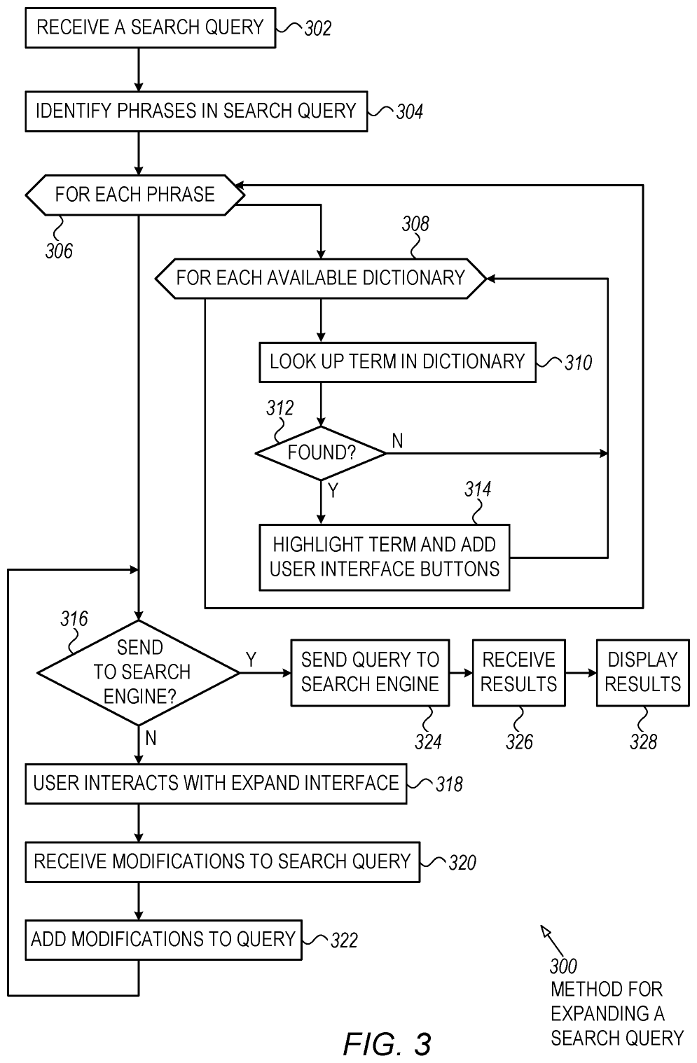

FIG. 3 is a flowchart illustration of an embodiment 300 showing a general method of enhancing a search query. The operations of embodiment 300 may represent those performed by a device that may parse a search query, identify search terms, and allow a user to identify enhancements or expansions to the search query, such as the device 202 illustrated in embodiment 200.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

A search query may be received in block 302. In many cases, the search query may be typed by a user, although sometimes search queries may be parsed from a spoken query.

Within the query, phrases may be identified in block 304. For each phrase in block 306, each available dictionary may be queried in block 308. The phrase may be looked up in the dictionary in block 310. If the term is found in a dictionary in block 312, the term may be highlighted and user interface buttons may be added in block 314. If the term is not found in block 312, the term is skipped.

After highlighting the search terms that may have been found in the dictionaries, the user may be able to interact with the user interface mechanisms to expand the search query. When the user interacts in block 318, modifications to the search query may be received in block 320, and those modifications may be added to the query in block 322.

Once all changes have been made to the query, the user may elect to send the query to a search engine in block 316. The enhanced search query may be sent in block 324 and results received in block 326. The results may be displayed in block 328.

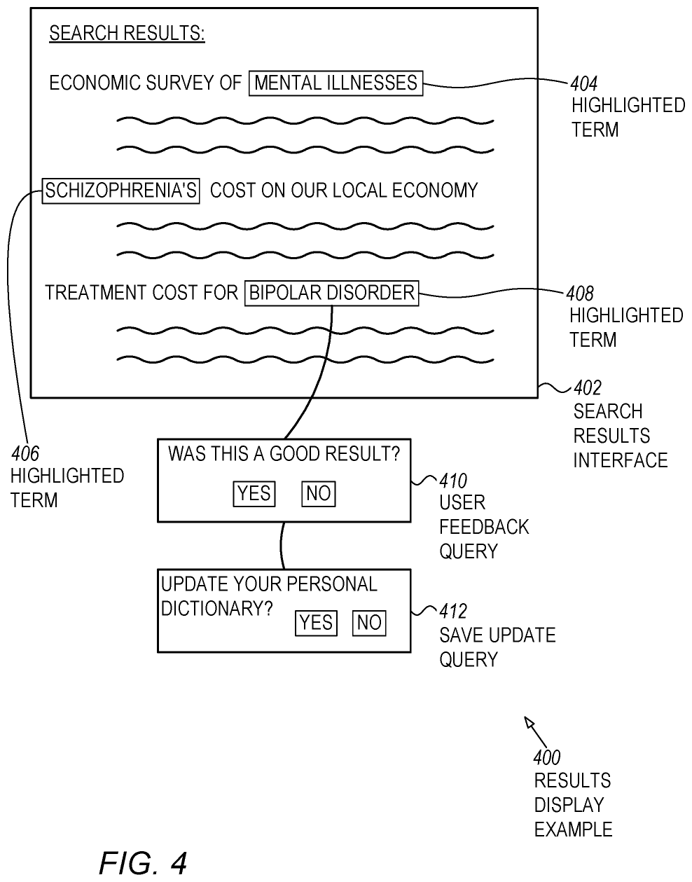

FIG. 4 is a diagram illustration of an example embodiment 400 showing a results display example. Embodiment 400 may illustrate a user interface and sequence where results from a query may be displayed, and information about those results may be gathered. The information may then be used to update a personal knowledge graph or preferences about the query.

Embodiment 400 may illustrate an example search results interface 402, which may have three different search results. In the example, a query using the generic term “mental illness” may be expanded to include several other specific mental illnesses, such as schizophrenia and bipolar disorder. As the results are presented in the example, the highlighted term 404 may be “mental illness,” in the second result, the term “schizophrenia” is highlighted term 406, and “bipolar disorder” is highlighted term 408.

The highlighted terms 404, 406, and 408 may represent the keywords from the original query, which is not shown. These keywords may be highlighted in different colors. For example, the main and more generic keyword “mental illness” may be presented in one color while the more specific instances of the generic keyword may be presented in one or more different colors for “schizophrenia” and “bipolar disorder.” The different colors may show the user that their original keyword was expanded to include other, more specific keywords. The different colors may also show results that may be more specific than the original query, which may aid a user in selecting which results may be relevant to their efforts.

A user interface may present a user feedback query 410. In the example, the user feedback query 410 may be linked to the highlighted term 408 of “bipolar disorder.” The user feedback query 410 may be triggered when a user clicks, hovers, or performs some other mouse or pointer operation near the highlighted term 408. In other cases, the user feedback query 410 may be presented when a user interacts with the search result, such as traversing a hyperlink to the search result, expands the search result to see more details, or other interaction.

Some systems may present a user feedback query 410 without user interaction with the specific search result. In such a use case, a user interface may present a user query feedback 410 for a search result that the user may have seemingly ignored. In such a use case, a system may sense that the user was less interested in that search result, and the system may ask if the user found the result relevant. If the user indicated that the result was not relevant, the system may remove similar results from future search results.

The user feedback query 410 may ask whether the user found the search results relevant, appropriate, or otherwise “good” or “bad.” When a user response is collected, a second user interface element 412 may ask if the user wanted their response saved. When the response is saved, future searches may be updated accordingly. When the response is not saved, the input collected from the user feedback query 410 may not affect future search results.

Some systems may collect “good” or “bad” information by implication. Some such systems may determine a user's interest in a search result by the interactions or non-interactions with the result. For example, a user who scans the result, expands the result to show more information, then clicks on the result may, by implication, indicate that the result may be relevant. In another example, a user may scroll past some search results and my interact with a lower-ranked result. Such results that may be scrolled past may be considered less relevant to the search results.

In many cases, the user feedback query 410 may collect information about the expansion of keywords that may have been performed at the query stage. The user feedback query 410 may specifically collect information about whether the expansion term “bipolar disorder” may have been a useful expansion of the term “mental illness” for the user's query. Such a use case for user feedback query 410 may not be as focused on the specific search results presented but may focus on the expansion or enhancement of the original keyword.

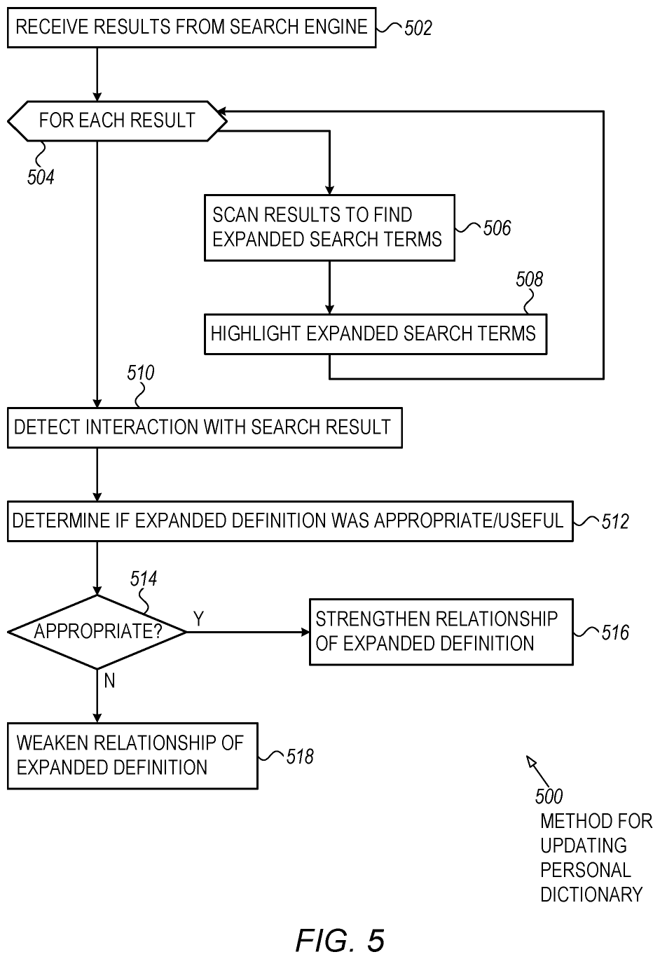

FIG. 5 is a flowchart illustration of an embodiment 500 showing a general method of updating a user's personal knowledge graph or preferences. The operations of embodiment 500 may represent the user interaction sequence illustrated in embodiment 400

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

Embodiment 500 may illustrate one example of updating a set of user preferences by analyzing search results and a user's interaction with those search results. Once the user's feedback is collected, preferences for the user may be stored.

The user's preferences may be stored in a user-specific or group-specific knowledge graph. This customized knowledge graph may capture the user's enhancements or expansion of certain keywords so that those enhancements may be reused in future queries. In the example of embodiment 400 where a user's query contains the keyword “mental illness,” future queries may automatically include “bipolar disorder” when those results may be relevant to past queries by that user.

Search results may be received from a search engine in block 502. For each search result in block 504, the results may be scanned in block 506 to identify expanded or enhanced search terms 508. The expanded or enhanced search terms may be highlighted in block 510. In some cases, the original search term may be highlighted in one color or visual effect, for example, while enhanced or expanded search terms may be highlighted in a second color or visual effect.

A determination may be made in block 510 about the user's interaction with the search result. In block 512, a determination may be made as to whether the enhanced or expanded search term was appropriate, useful, or otherwise helpful to the user.

In some cases, the user may be queried specifically about the search result, such as the example of user interface query 410. In other cases, a user's interaction may be implied. For example, a user may be credited with liking the result when the user interacted with the result or disliking the result when the user did not interact with the result.

If the search term enhancement or expansion was appropriate in block 514, the relationship between the original search term and the enhancements may be strengthened in block 516. When the search term enhancement as not appropriate in block 514, the relationship may be weakened in block 518.

Some systems may use a knowledge graph to represent and store user preferences. Such a knowledge graph may have topics or keywords as nodes on the graph, with relationships between those keywords as edges of the graph. By increasing or decreasing the strength of these relationships, the knowledge graph may capture the user's preferences for certain enhancements or expansion of specific keywords. In future queries, the user's preferences may be presented as an enhancement option for certain keywords. Some systems may overlay, aggregate, or combine multiple knowledge graphs for keyword enhancements. In one such example, a professionally curated knowledge graph on psychiatric diseases may be aggregated with a user's preference knowledge graph to highlight the user's interest in specific mental illnesses.

The foregoing description of the subject matter has been presented for purposes of illustration and description. It is not intended to be exhaustive or to limit the subject matter to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments except insofar as limited by the prior art.

What is claimed is:

1. A search system comprising:
at least one processor, said at least one processor configured to execute a search interface, said search interface comprising:
a search query input mechanism that receives a first search query;
a highlighter that identifies a first search term within said first search query, said first search term having a first expanded definition;
a term expander that receives a term expansion input and expands said first search term to include at least a portion of said first expanded definition.

2. The search system of claim 1, said search query input mechanism gathering text input from a user.

3. The search system of claim 2, said highlighter changing a visual appearance of said first search term.

4. The search system of claim 3, said term expansion input being a selection of said first search term.

5. The search system of claim 1, said search query input mechanism gathering an audio search query.

6. The search system of claim 1 further displaying at least a portion of said first expanded definition.

7. The search system of claim 6 further comprising an expansion selection mechanism gathering input to identify said at least a portion of said first expanded definition.

8. The search system of claim 7, said first expansion definition comprising a first expanded element and a second expanded element, said at least a portion of said first expanded definition comprising said first expanded element and not comprising said second expanded element.

9. The search system of claim 1 further comprising a first expansion dictionary comprising said first expanded definition for said first search term.

10. The search system of claim 9 further comprising a second expansion dictionary comprising a second expanded definition for said first search term.

11. The search system of claim 10 further comprising a dictionary selection mechanism through which said first expansion dictionary is selected.

12. The search system of claim 11 further displaying at least a portion of said first expanded definition and said second expanded definition.

13. The search system of claim 1, said search interface comprising:
a search system interface that causes a search to be performed using said at least a portion of said first expanded definition.

14. The search system of claim 13, said search system transmitting a query comprising Boolean OR statements comprising said at least a portion of said first expanded definition.

15. The search system of claim 14, said Boolean OR statements being editable prior to causing said search to be performed.

16. The search system of claim 13, said search system interface that further causes a first set of search results to be presented.

17. The search system of claim 16, said first set of search results being displayed such that said at least a portion of said first expanded definition is highlighted.
